(19) United States
(12) Patent Application Publication
(10) Pub. No.: US 2026/0084777 A1
(43) Pub. Date: Mar. 26, 2026

(54) Folding Mobility Device

(71) Applicant: MA Micro Limited, London (GB)

(72) Inventors: Rich Clarke, Woking (GB); Michael Owen Sexton, Woking (GB); Andrew Murray Charles Odhams, Woking (GB); Albert Nassar, Woking (GB); Diego Valdes, Woking (GB); Toby Woodcock, Woking (GB)

(21) Appl. No.: 19/109,763

(22) PCT Filed: Sep. 8, 2023
(86) PCT No.: PCT/GB2023/052335

§ 371 Date: Mar. 7, 2025

(30) Foreign Application Priority Data
Sep. 9, 2022 (GB) 2213235.1

(51) Int. Cl. B62K 15/00; B62K 3/00; B62K 21/02

(52) U.S. Cl. CPC B62K 15/008; B62K 3/002; B62K 21/02

(57) ABSTRACT

A mobility device for transporting a user, the mobility device including a first wheel; a second wheel; a headtube coupled to the first wheel; a body configured to support the user, the body being coupled to the second wheel; a first linkage connected between the headtube and the body, the first linkage being pivotally coupled to the headtube and to the body; and a second linkage connected between the headtube and the body, the second linkage being pivotally coupled to the headtube and to the body. The first and second linkages permit the headtube to rotate and translate relative to the body to move between a deployed configuration and a folded configuration of the mobility device.

### CROSS-REFERENCE TO RELATED APPLICATIONS

This application is the United States national phase of International Patent Application No. PCT/GB2023/052335, filed Sep. 8, 2023, and claims priority to United Kingdom Patent Application No. 2213235.1, filed Sep. 9, 2022, the disclosures of which are hereby incorporated by reference in their entireties.

### BACKGROUND OF THE INVENTION

### Field of the Invention

This invention relates to a mobility device such as an electric scooter.

### Description of Related Art

It is becoming increasingly common for people to travel around using personal mobility devices. These mobility devices may be in the form of a scooter. The mobility devices may have at least one front wheel and one rear wheel with a platform in between to support the user of the mobility device. The user may stand on the platform to ride the mobility device. The user may hold on to part of the mobility device to gain support when the mobility device is in motion. For instance, the mobility device may have a stem and a grip, such as handlebars, to hold on to. The user may be able to steer the mobility device using the part that they hold on to.

In some cases, the personal mobility devices are self-powered. They have an energy source coupled to a power source. The power source drives at least one of the wheels of the mobility device. The energy source may be a battery and the power source may be an electric motor.

It is desirable for the personal mobility devices to be portable so that they can be stored when not in use and/or be portable between locations where they are going to be used. For instance, the mobility device may be taken on a train or put in a car to be used at a destination after travelling. In these situations, it is useful if the mobility device can be put into a configuration where it takes up less space. Many personal mobility devices have some form of ability to move from a useable configuration to a more compact configuration. For instance, the personal mobility device may fold flat or a piece may be removable such as the stem and handlebars. In both cases, the overall length of the personal mobility device is unchanged. This can cause problems when attempting to transport or store the personal mobility device.

It would therefore be desirable for there to be a mobility device which has more compact dimensions when being stored or transported.

### SUMMARY OF THE INVENTION

According to a first aspect of the present invention there is provided a mobility device for transporting a user, the mobility device comprising: a first wheel; a second wheel; a headtube coupled to the first wheel; a body configured to support the user, the body being coupled to the second wheel; a first linkage connected between the headtube and the body, the first linkage being pivotally coupled to the headtube and to the body; and a second linkage connected between the headtube and the body, the second linkage being pivotally coupled to the headtube and to the body; wherein the first and second linkages permit the headtube to rotate and translate relative to the body to move between a deployed configuration and a folded configuration of the mobility device.

According to a second aspect of the present invention there is provided a mobility device for transporting a user, the mobility device comprising: a first wheel; a second wheel; a headtube coupled to the first wheel; a body configured to support the user, the body being coupled to the second wheel; a first linkage connected between the headtube and the body, the first linkage being pivotally coupled to the headtube and to the body; and a second linkage connected between the headtube and the body, the second linkage being pivotally coupled to the headtube and to the body; wherein the first and second linkages permit the headtube to rotate and translate relative to the body to move between a deployed configuration and a folded configuration of the mobility device; and wherein one of the first and second linkages comprises a protrusion, and the body comprises a locking mechanism to hold the mobility device in the deployed configuration, the protrusion fitting into the locking mechanism to hold the mobility device in the deployed configuration.

The headtube may be configured to engage with the body proximal to the second wheel in the folded configuration.

According to a third aspect of the present invention there is provided a mobility device for transporting a user, the mobility device comprising: a first wheel; a second wheel; a headtube coupled to the first wheel; a body configured to support the user, the body being coupled to the second wheel; a first linkage connected between the headtube and the body, the first linkage being pivotally coupled to the headtube and to the body; and a second linkage connected between the headtube and the body, the second linkage being pivotally coupled to the headtube and to the body; wherein the first and second linkages permit the headtube to rotate and translate relative to the body to move between a deployed configuration and a folded configuration of the mobility device, and wherein the headtube is configured to engage with the body proximal to the second wheel in the folded configuration.

The mobility device may comprise a front fork, the front fork may be attached to the first wheel to permit the first wheel to rotate about a first rolling axis; wherein the first wheel may be coupled to the headtube by the front fork so that the first rolling axis has freedom to rotate relative to the headtube. The body may be coupled to the second wheel to permit the second wheel to rotate about a second rolling axis. The first wheel may have a first rolling axis and the second wheel may have a second rolling axis; in the deployed configuration the mobility device may have a first distance between the first rolling axis and the second rolling axis; in the folded configuration the mobility device may have a second distance between the first rolling axis and the second rolling axis; and the second distance may be less than the first distance.

In the folded configuration the first wheel may be located inboard of a front edge of the body. In the deployed configuration the first wheel may be located outboard of a front edge of the body.

The first linkage may be pivotally coupled to the headtube at a first location, the second linkage may be pivotally coupled to the headtube at a second location, and the first location may be positioned closer to the first wheel on the headtube than the second location. The first linkage may be pivotally coupled to the body at a third location, the second linkage may be pivotally coupled to the body at a fourth location, and the fourth location may be positioned closer to the second wheel on the body than the third location.

In the deployed configuration the first wheel may be positioned to contact a running surface. The first linkage may comprise a curved profile proximal to where the first linkage is coupled to the body and a straight profile proximal to where the first linkage is coupled to the headtube. The second linkage may comprise a curved profile proximal to where the second linkage is coupled to the body and a straight profile proximal to where the second linkage is coupled to the headtube.

One of the first and second linkages may comprise a protrusion, and the body may comprise a locking mechanism to hold the mobility device in the deployed configuration, the protrusion may fit into the locking mechanism to hold the mobility device in the deployed configuration. The mobility device may comprise a front fork, a stem, and a securing device, the front fork and the stem may be pivotally connected together and the securing device may limit the motion of the stem relative to the front fork so that the stem and front fork are lockable in a deployed configuration and a folded configuration. The securing device may comprise a button to unlock the securing device and the securing device may be coupled to the locking mechanism to unlock the locking mechanism when the securing device unlocks.

The first wheel may have a first rolling axis and the second wheel may have a second rolling axis; in the folded configuration the mobility device may have a second distance between the first rolling axis and the second rolling axis; the mobility device may have a third distance between a front edge of the body and the second rolling axis; and the second distance may be less than the third distance.

The headtube may be configured to engage with the body proximal to the second wheel in the folded configuration through the securing device.

The stem may be configured to engage with the body proximal to the second wheel in the folded configuration through the securing device.

The securing device may comprise a body hook. The body may comprise a plate located proximal to the second wheel. The plate may comprise an aperture. The body hook may be configured to engage with the aperture in the folded configuration.

The plate may extend away from a first surface of the body. The first surface may face away from a running surface that the wheels contact with when the mobility device is in the deployed configuration.

### BRIEF DESCRIPTION OF THE DRAWINGS

The terms Fig., Figs., Figure, and Figures are used interchangeably in the specification to refer to the corresponding figures in the drawings.

The present invention will now be described by way of example with reference to the accompanying drawings. In the drawings:

FIG. 1 shows a side view of a mobility device in a deployed configuration.

FIG. 2 shows a side view of the mobility device in a configuration between the deployed configuration and a folded configuration.

FIG. 3 shows a side view of the mobility device in a folded configuration.

FIG. 4 shows a perspective view of the mobility device from the rear of the mobility device in the deployed configuration.

FIG. 5 shows a perspective view of the mobility device from the rear of the mobility device in the folded configuration.

FIG. 6 shows a perspective view of the mobility device from the front of the mobility device in the deployed configuration.

FIG. 7 shows a perspective view of the mobility device from the front of the mobility device in the folded configuration.

FIG. 8 shows a partially see-though view of a body of the mobility device.

FIGS. 9 and 10 show a portion of the body with the body being shown partially see-through.

FIG. 11 shows a portion of the mobility device with a second linkage removed.

FIG. 12 shows a close up view of a connection between a stem and a front fork with the stem and front fork in a deployed configuration.

FIG. 13 shows a close up view of a connection between a stem and a front fork with the stem and front fork in a partially folded configuration.

FIG. 14 shows a close up view of a connection between a stem and a front fork with the stem and front fork in a folded configuration.

### DESCRIPTION OF THE INVENTION

The following description is presented to enable any person skilled in the art to make and use the invention, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The present invention relates to a mobility device for transporting a user, the mobility device comprising: a first wheel, a second wheel, a headtube coupled to the first wheel and a body configured to support the user, the body being coupled to the second wheel.

The mobility device further comprises a first linkage connected between the headtube and the body, the first linkage being pivotally coupled to the headtube and to the body, and a second linkage connected between the headtube and the body, the second linkage being pivotally coupled to the headtube and to the body. The first and second linkages permit the headtube to rotate and translate relative to the body to move between a deployed configuration and a folded configuration of the mobility device. The mobility device may be a scooter. The first and second linkages may be the only connections between the headtube and the body.

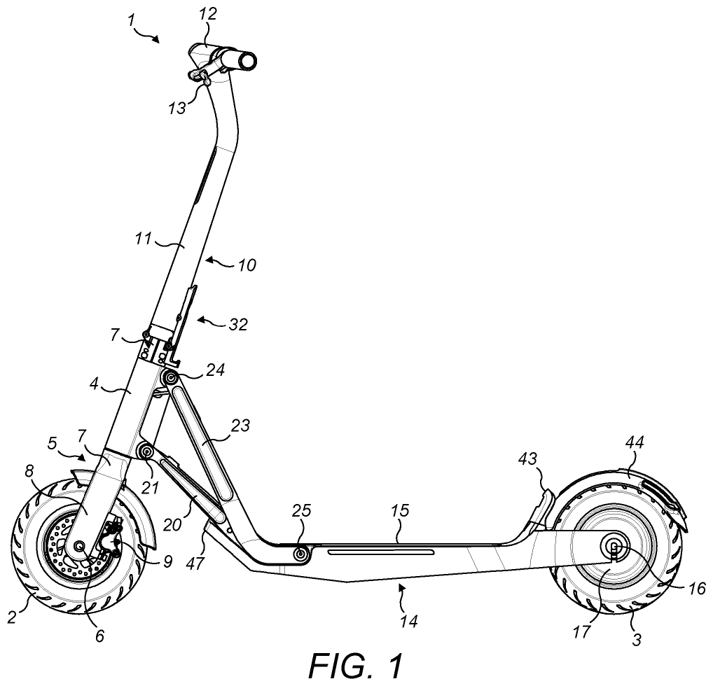

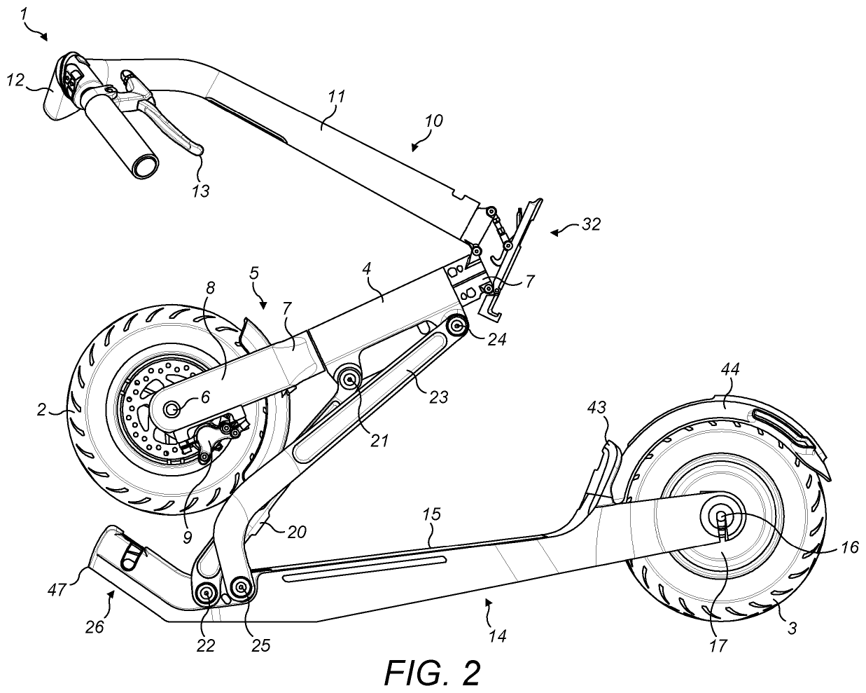

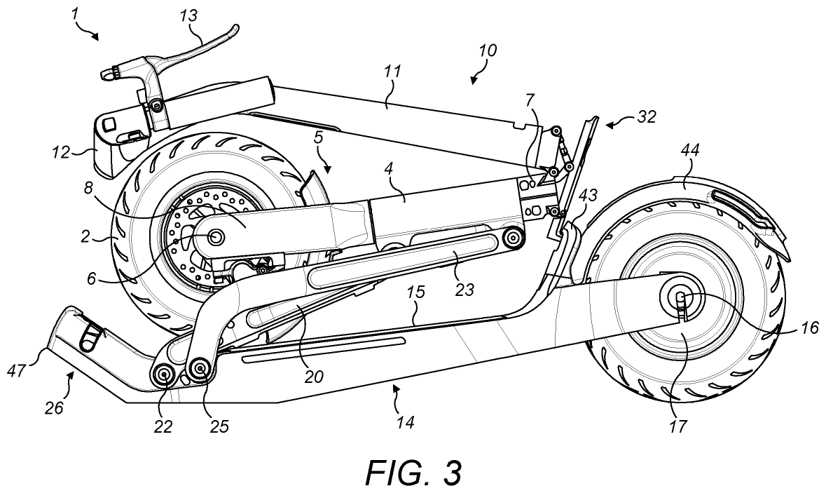

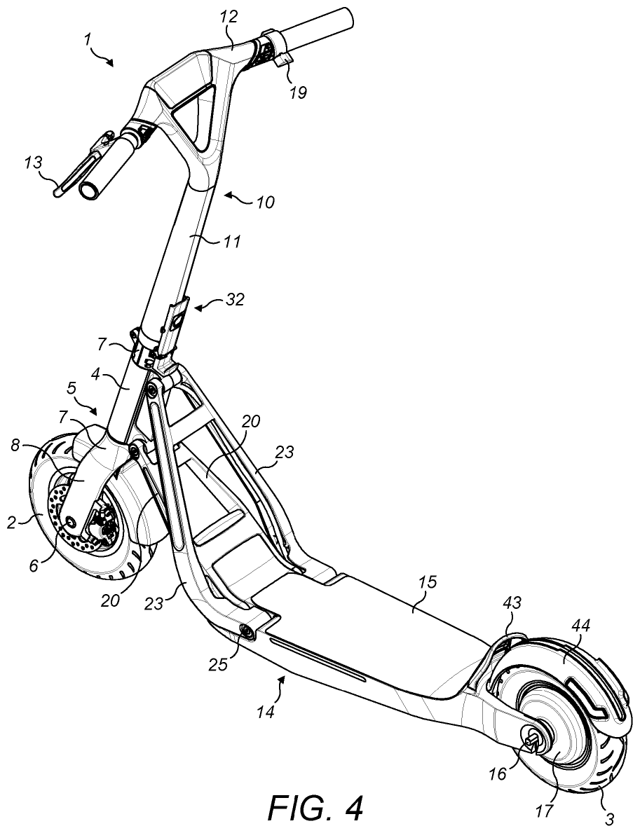

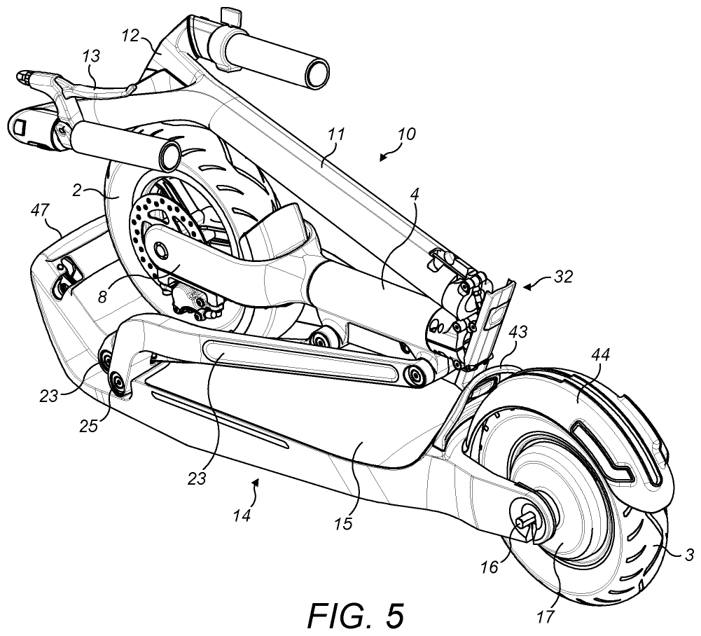

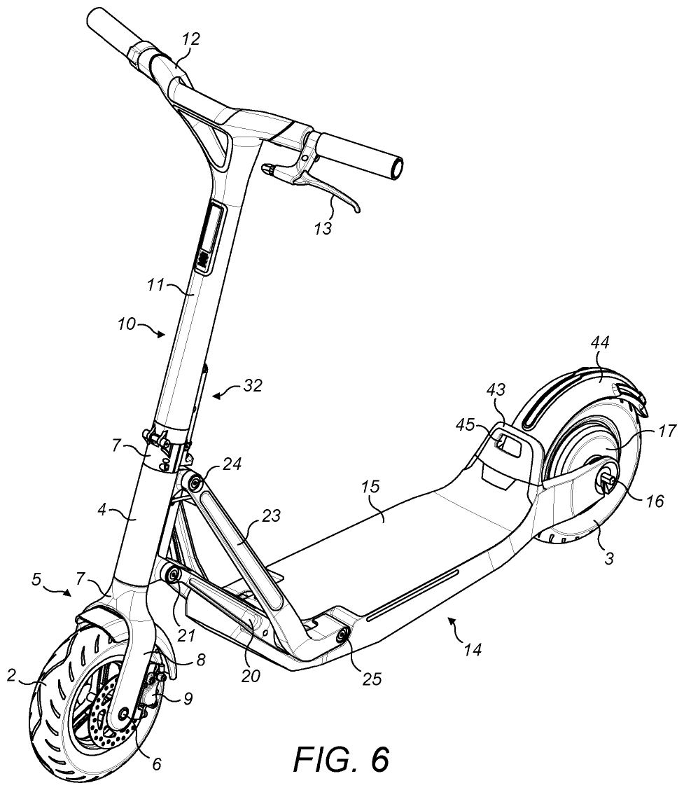

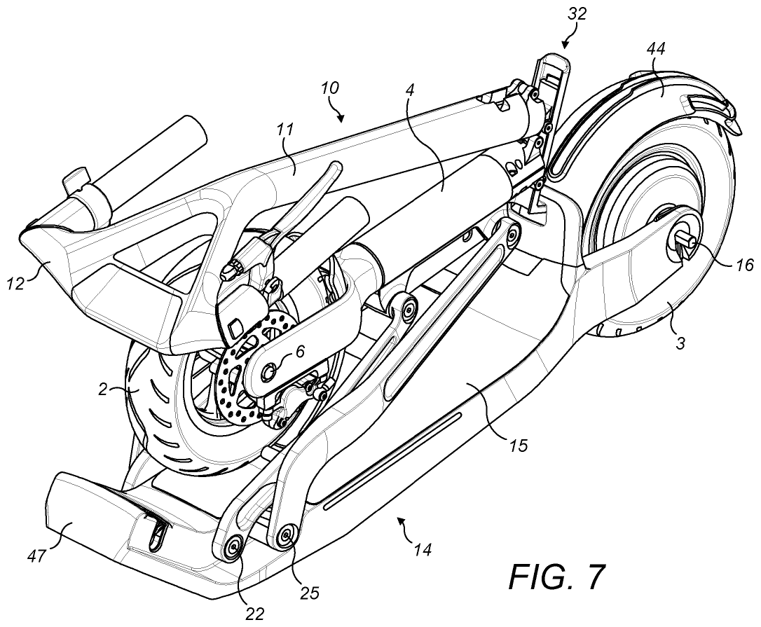

FIGS. 1 to 7 shows various views of a mobility device 1 for transporting a user. The mobility device 1 may be a personal mobility device 1. As shown in the figures, the mobility device 1 is a scooter. FIGS. 1, 4 and 6 show the mobility device 1 in a deployed configuration. FIGS. 3, 5 and 7 show the mobility device 1 in a folded configuration. FIG. 2 shows the mobility device 1 in a configuration between the deployed configuration and the folded configuration. The mobility device 1 is in a partially folded configuration in FIG. 2. FIGS. 1 to 3 are side views of the mobility device 1. FIGS. 4 and 5 are perspective views from the rear of the mobility device 1. FIGS. 6 and 7 are perspective views from the front of the mobility device 1.

The mobility device 1 comprises a first wheel 2 and a second wheel 3. The first wheel 2 is a front wheel 2. The second wheel 3 is a rear wheel 3. It will be appreciated that whilst the mobility device 1 is shown with two wheels, the mobility device 1 could comprise more than two wheels. For instance, the mobility device 1 could comprise two front wheels. The mobility device 1 could comprise two rear wheels. In each case, the wheels could be mounted next to each other. The front of the mobility device 1 is defined with reference to the primary motion direction of the mobility device 1. The front of the mobility device 1 points in the primary motion direction of the mobility device 1.

The mobility device 1 comprises a headtube 4. The headtube 4 is coupled to the first wheel 1. The headtube 4 may be formed of one piece or may be constituted from multiple components that together form the headtube 4. The headtube 4 is coupled to the first wheel 1 by a front fork 5. The front fork 5 is rotatably connected to the headtube 4. The front fork 5 passes through headtube 4. The front fork 5 is connected to the headtube 4 by a bearing so that the front fork 5 can rotate relative to the headtube 4 to provide steer to the front wheel 1. The first wheel 1 is attached to the front fork 5. The first wheel 1 is attached to the front fork 5 to permit the first wheel to rotate about a first rotation axis 6. The first rotation axis 6 may be known as a first rolling axis 6. The first wheel 1 is coupled to the headtube 4 so that the first rolling axis 6 has freedom to rotate related to the headtube. In this way, the front wheel 2 can pivot to provide steer. The first wheel 1 may be attached to the front fork 5 by a bearing to provide the rotational freedom required.

The front fork 5 is shown as having a fork body 7 which passes through the headtube 4. The front fork 5 is shown as having a pair of fork projections 8 which pass to either side of the first wheel 2. The front fork 5 attaches to the first wheel 2 by the fork projections 8. It will be appreciated that the front fork 5 may comprise one fork projection 8 which passes to one side of the first wheel 2 and attaches only to one side of the front wheel 2. In this way the front fork 5 may comprise one or two fork projections 8. The fork projection(s) 8 attach to the first wheel 2.

The first wheel 2 may be attached to a first brake 9. The first brake 9 is controllable by the user to provide the ability to limit or stop the rotation of the first wheel 2. In the figures, the first brake 9 is shown as being a disc brake with a disc attached to the first wheel 2 and a calliper attached to the front fork 5. It will be appreciated that other types of brake may be used. The first brake 9 may be controllable by the user using a user interface that the user can interact with. The user interface may be a brake lever.

The fork body 7 is attached to a stem 10. The stem 10 comprises a stem body 11 and handlebars 12. The stem body 11 is attached to handlebars 12. The stem body 11 is attached to the fork body 7. The stem body 11 is attached to the fork body 7 so that when the mobility device 1 is in the deployed configuration the stem 10 can be used to move the first wheel 2. The stem 10 can be used to steer the first wheel 2. The handlebars 12 are configured to be gripped by the user. In this way, the user can steer the first wheel 2. The user interface for the first brake 9 may be attached to the handlebars. E.g., the brake lever 13 may be attached to the handlebars 12.

As shown in the figures, the handlebars 12 are rotatable between a useable configuration and a stowed configuration. The handlebars 12 are in the useable configuration when the mobility device 1 is in the deployed configuration. The handlebars 12 are moved to the stowed configuration by the user when the mobility device 1 is in the folded configuration. This is so that the handlebars 12 do not project as far laterally when the mobility device 1 is in the folded configuration.

The mobility device 1 comprises a body 14. The body 14 is configured to support the user. The body 14 may be configured so that the user can stand on the body 14. The body 14 may be configured so that feet of the user can be supported by the body 14. The body 14 has a first surface 15 that, when the mobility device is in the deployed configuration, faces away from a running surface that the wheels 2, 3 contact with. The user is supported by the first surface 15.

The body 14 is coupled to the second wheel 3. The body 14 is coupled to the second wheel 3 to permit the second wheel to rotate about a second rotation axis 16. The second rotation axis 16 may be known as a second rolling axis 16. The second wheel 3 may be attached to the body 14 by a bearing to provide the rotational freedom required. The mobility device 1 comprises a motor 17. The motor 17 powers the second wheel 3. The motor 17 is controllable to cause the second wheel 3 to rotate. The motor 17 may be attached to the second wheel 3. The motor 17 may be a hub motor. The motor 17 may be a hub motor which is formed as part of the second wheel. The hub motor reacts against the connection of the body 14 to the second wheel 3 to permit the second wheel 3 to be driven. Alternatively, the motor 17 may be connected to the second wheel 3 via a drivetrain. The drivetrain may comprise one or more gears and/or drive belts. The motor 17 may be an electric motor. The motor 17 may be an internal combustion engine.

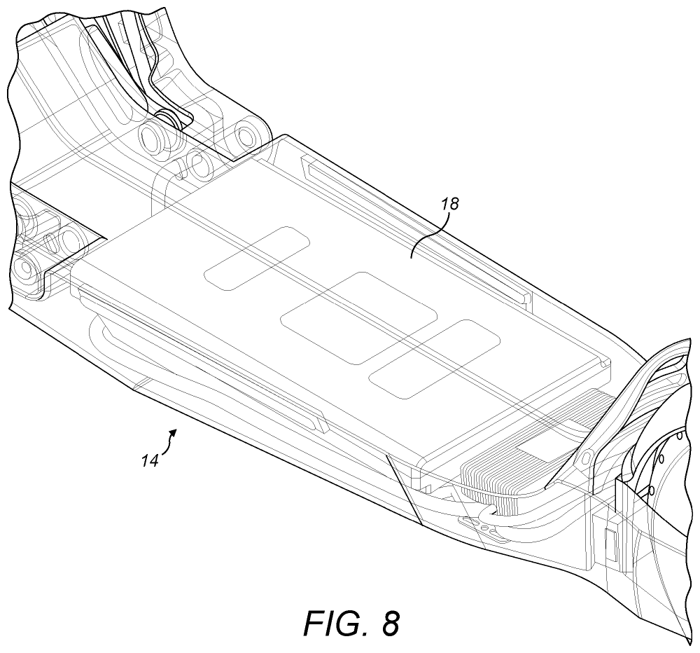

FIG. 8 shows a partially see-though view of the body 14. The mobility device 1 comprises a power source 18. The power source 18 may be a battery 18. The power source 18 is coupled to the motor 17. The power source 18 is configured to provide power to the motor 17. In the case that the motor 17 is an electric motor 17 then the power source 18 may be a battery 18. The power source 18 may be a fuel tank. The mobility device 1 comprises a user interface to control the power provided to the motor 17. The user interface may be a throttle 19. The throttle 19 may be attached to the handlebars 12.

The body 14 is connected to the headtube 4 by a pair of linkages on each side of the body 14. In this way, the body 14 is coupled to the first wheel 1. The body 14 is coupled to the first wheel 1 by a pair of linkages on each side of the body 14. It will be appreciated that although the pictured mechanism has a pair of linkages on each side of the body a single pair of linkages could be used to obtain the required motion path of the headtube 4. As shown in the figures, the each of the first linkages and each of the second linkages may be joined to their respective pair on the other side of the body.

A first linkage 20 is connected between the headtube 4 and the body 14. The first linkage 20 is pivotally coupled to the headtube 4. The first linkage 20 is pivotally coupled to the body 14. The rotational axis of pivots is in a lateral direction of the mobility device 1. The first linkage 20 is pivotally coupled to the headtube 4 at a first location 21. The first location is on the headtube 4. The first linkage 20 is pivotally coupled to the body 14 at a third location 22. The third location 22 is on the body 14. The first linkage 20 has a curved profile in a region close to where the first linkage 20 is coupled to the body 14. Thus, the first linkage 20 has a curved profile proximal to where the first linkage 20 is coupled to the body 14. The first linkage 20 has a curved profile in a region close to where the first linkage 20 is coupled to the headtube 4. Thus, the first linkage 20 has a straight profile proximal to where the first linkage is coupled to the headtube 4.

A second linkage 23 is connected between the headtube 4 and the body 14. The second linkage 23 is pivotally coupled to the headtube 4. The second linkage 23 is pivotally coupled to the body 4. The rotational axis of the pivots is in a lateral direction of the mobility device 1. The second linkage 23 is pivotally coupled to the headtube 4 at a second location 24. The second location 24 is on the headtube 4. The second linkage 23 is pivotally coupled to the body 14 at a fourth location 25. The fourth location 25 is on the body 14. The second linkage 23 has a curved profile in a region close to where the second linkage 23 is coupled to the body 14. Thus, the second linkage 23 has a curved profile proximal to where the second linkage 23 is coupled to the body 14. The second linkage 23 has a curved profile in a region close to where the second linkage 23 is coupled to the headtube 4. Thus, the second linkage 23 has a straight profile proximal to where the first linkage is coupled to the headtube 4.

The first linkage 20 is located inboard of the second linkage 23. Thus, the second linkage 23 is located outside of the first linkage 20. In this way, the first linkage 20 is located closer to the body 14 than the second linkage 23. Alternatively, the second linkage could be located inboard of the first linkage 20. Thus, the first linkage 20 may be located outside of the second linkage 23. In this way, the second linkage 23 may be located closer to the body 14 than the first linkage 20. The offset nature of the first and second linkages 20, 23 permits the first and second linkages 20, 23 to move past each other.

The pivotal coupling of the first and second linkage 20, 23 to the headtube 4 may be in the form of a pin either attached to or formed as part of the headtube 4 over which the first and second linkages fit. The first and second linkages 20, 23 may comprise a bearing which fits over the pin to permit rotational motion relative to the pin.

As shown in the figures, the first location 21 is positioned on the headtube 4 closer to the first wheel 2 than the second location 24. The second location 24 is positioned on the headtube 4 farther from the first wheel 2 than the first location 21. The first location 21 is positioned at one end of the headtube 4. The second location 24 is positioned at the other end of the headtube 4 remote from the first location 21. The first and second locations 21, 24 are positioned on a portion of the headtube 4 that is closest to the body 14. The first and second locations 21, 24 are positioned on a line that runs parallel to the axial direction of the headtube 4. The axial direction being the direction that runs towards the first wheel 2. The axial direction being the direction along which the front fork 5 runs through the headtube 4. The fork body 7 runs through the headtube 4 along the axial direction.

The third location 22 is positioned on the body 14 farther from the second wheel 3 than the fourth location 25. The fourth location 25 is positioned on the body 14 closer to the second wheel than the third location 22. The third and fourth locations 22, 25 are positioned on the body 14 towards the end of the body remote from the second wheel 3. The third location 22 is positioned closer to the end of the body remote from the second wheel 3 than the fourth location 25.

A first pair of first and second linkages 20, 23 may be located to one side of the body 14 and headtube 4. A second pair of first and second linkages 20, 23 may be located to the other side of the body and headtube 4. The first and second pair of linkages 20, 23 are spaced from each other in the lateral direction of the mobility device 1. The first and second pair of linkages 20, 23 are positioned either side of a longitudinal centreline of the mobility device 1. The first to fourth locations 21, 24, 22, 25 for each pair of first and second linkages 20, 23 are located on opposite sides of the headtube 4 or body 14 as appropriate. The first and second locations 21, 24 for each pair of first and second linkages 20, 23 are located on opposite sides of the headtube 4. The third and fourth locations 22, 25 for each pair of first and second linkages 20, 23 are located on opposite sides of the body 14.

The first linkages 20 on either side of the body 14 may be attached to each other through the body so that both first linkages 20 move in unison. The second linkages 23 on either side of the body 14 may be attached to each other though the body so that both second linkages 23 move in unison.

The pivotal coupling of the first and second linkages 20, 23 to the body 14 may be in the form of a pin either attached to or formed as part of the body 14 over which the first and second linkages 20, 23 fit. The first and second linkages 20, 23 may comprise a bearing which fits over the pin to permit rotational motion relative to the pin.

Advantageously, the pivotal coupling of the first and second linkages 20, 23 to the body 12 may each be in the form of a rod that runs through the body 14. The first linkages 20 on each side of the body 14 may attach to the rod associated with the first linkages 20. The first linkages 20 may be attached securely to the rod so that both first linkages 20 move in unison. The second linkages 23 on each side of the body 14 may attach to the rod associated with the second linkages 23. The second linkages 23 may be attached securely to the rod so that both second linkages 23 move in unison.

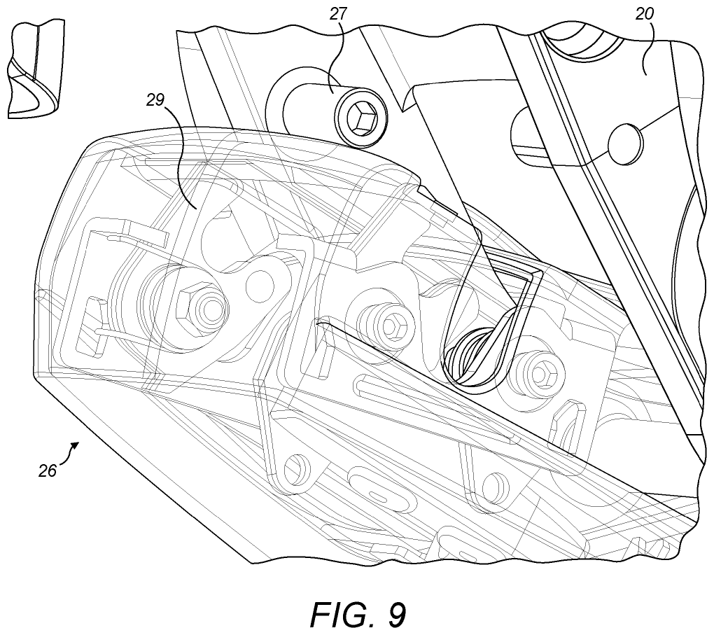

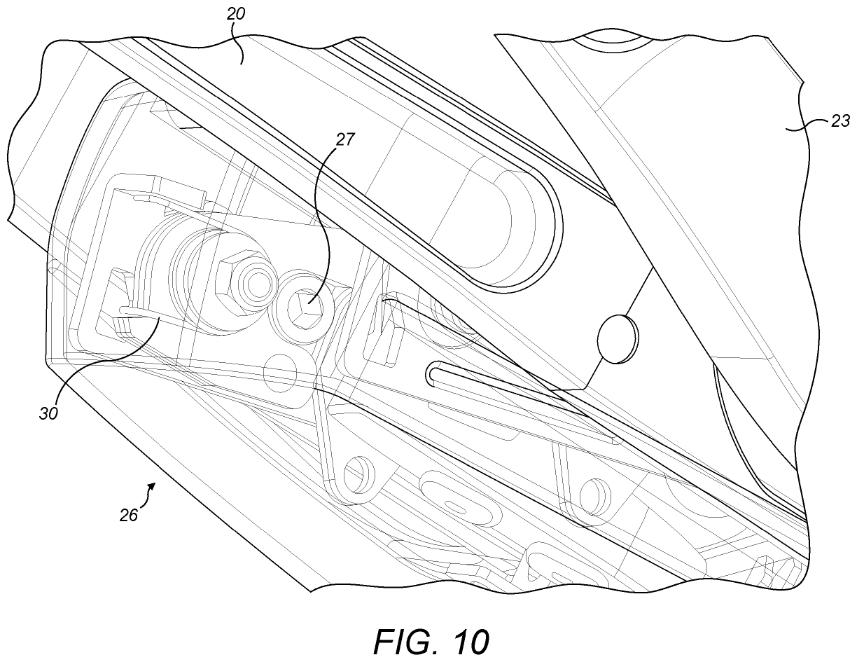

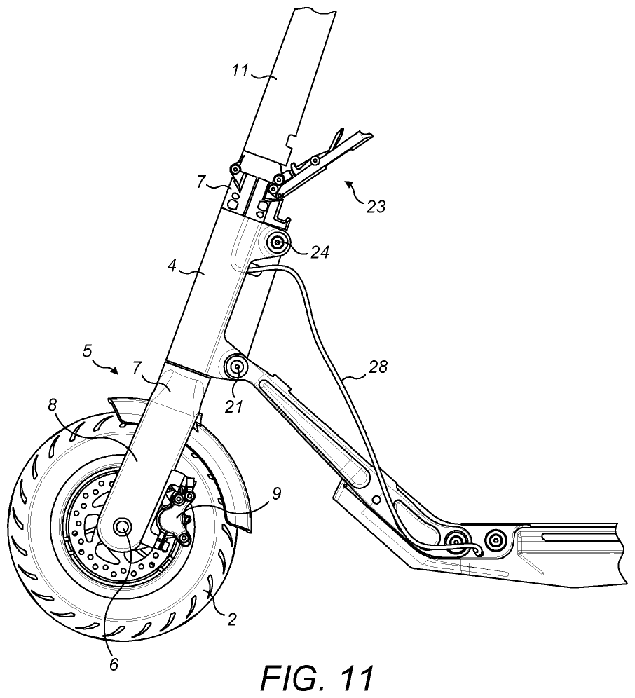

FIGS. 9 and 10 show a portion of the body 14 of the mobility device 1 with the body 14 being shown partially see-through. One of the linkages is also shown. In FIGS. 9 and 10 the first linkage 20 is shown. FIG. 11 shows a portion of the mobility device 1 with the second linkage 23 removed.

The body 14 comprises a locking mechanism 26 to hold the mobility device 1 in the deployed configuration. One of the first or second linkages comprises a protrusion 27 which fits into the locking mechanism 26. The first linkage 20 may comprise the protrusion 27. The second linkage 23 may comprise the protrusion 27. In the figures, the first linkage 20 comprises the protrusion 27.

The locking mechanism 26 can selectively hold the protrusion securely within the locking mechanism 26. The locking mechanism 26 has a locked configuration and an unlocked configuration. When the locking mechanism 26 is in the locked configuration the locking mechanism 26 holds the protrusion 27 securely within the locking mechanism 26. When the locking mechanism 26 is in the unlocked configuration the locking mechanism 26 permits the protrusion 27 to be removed from the locking mechanism 26. When the locking mechanism 26 is in the unlocked configuration the locking mechanism 26 permits the protrusion 27 to be inserted into the locking mechanism 26. When the protrusion 27 is inserted into the locking mechanism 26 the locking mechanism 26 may automatically engage the locked configuration. The locking mechanism 26 may transition from the locked configuration to the unlocked configuration in response to a user input. The user input may be supplied by a button on the body 14. The user input may be supplied to the locking mechanism 26 by means of a control cable 28. In this way, a control cable may be connected to the locking mechanism 26 to control the transition of the locking mechanism 26 from the locked configuration to the unlocked configuration. The control cable 28 is shown in FIG. 11 as being routed through the second linkage 23. However, any suitable route could be taken for the control cable 28 to a position where user input can be provided. The control cable 28 may be a Bowden cable.

The locking mechanism may comprise a locking member 29. The locking member 29 is shaped to receive the protrusion 27. The locking member 29 comprises a U-shaped cut out into which the protrusion 27 can be inserted. The locking member 29 is attached to the locking mechanism to rotate between a locked position and an unlocked position. In the locked position, the locking member 29 holds the protrusion 27 securely. In the unlocked position, the protrusion 27 is free to move in and out of the locking member 29. The locking member 29 may be held in the locked position by a resilient biasing means 30 such as a spring. The biasing means 30 may be released in response to the user input.

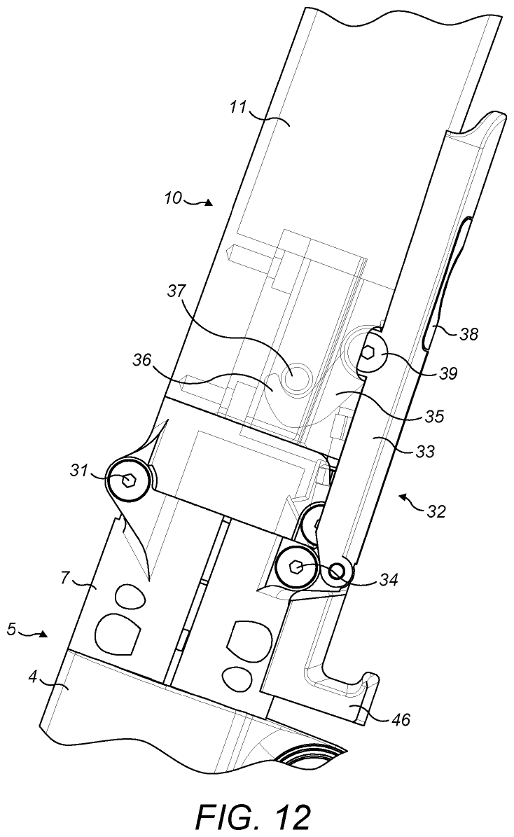

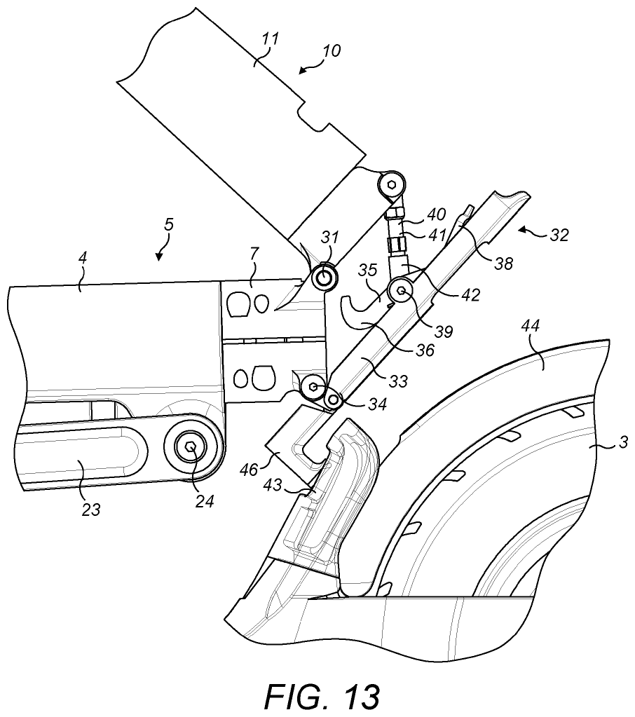

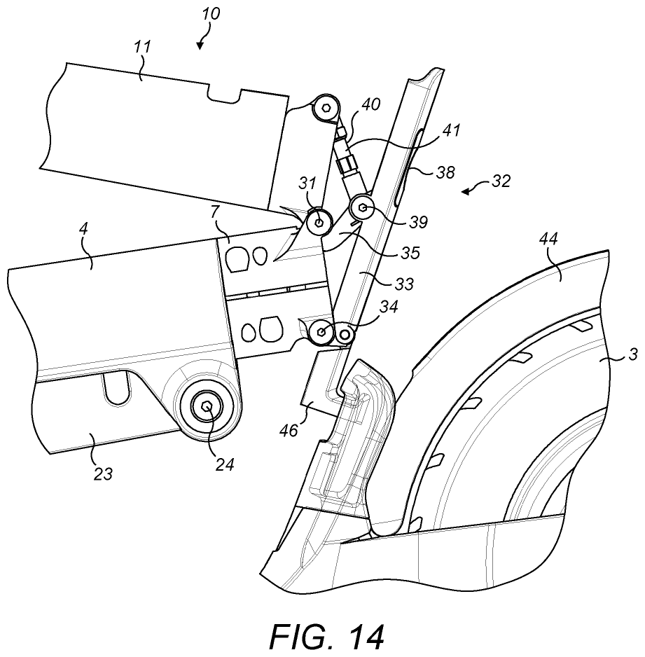

FIGS. 12 to 14 show close up views of part of the mobility device 1 focussing on the connection between the stem 10 and the front fork 5. As shown in FIGS. 2, 3 5 and 7, the connection between the stem 10 and the front fork 5 permits the two to move relative to each other when the mobility device 1 moves between the deployed configuration and the folded configuration. The stem 10 and the front fork 5 fold relative to each other. In the deployed configuration, the stem 10 and the front fork 5 run contiguously in the region where the two meet. In the folded configuration, the stem 10 is hinged relative to the front fork 5 so that the two are located one next to the other. In the folded configuration, the stem 10 is positioned farther from the body 14 than the front fork 5. In the folded configuration, the front fork 5 is positioned between the stem 10 and the body 14.

The front fork 5 and the stem 10 are connected together by a hinge 31. In this way, the front fork 5 and the stem 10 are pivotally connected. The hinge 31 is connected between the fork body 7 and the stem 10. The hinge 31 is connected to the stem body 11. The hinge 31 permits the stem 10 to rotate relative to the front fork 5. The stem 10 rotates in a generally forward direction when moving between the deployed configuration and the folded configuration when the front wheel 2 is pointing in a forward direction.

To limit the motion of the stem 10 relative to the front fork 5 during use, the mobility device 1 comprises a securing device 32. The securing device 32 comprises a securing device body 33. The securing device body 33 is hinged to the front fork 5. The securing device body 33 is hinged to the fork body 7. The hinge 34 is connected between the securing device body 33 and the fork body 7. The hinge 34 permits the securing device body 33 to move away from the stem 10 to unlock the stem 10 from the front fork 5 to permit the stem 10 to rotate relative to the front fork 5. The securing device 33 comprises a rocker 35. The rocker 35 can pivot relative to the securing device body 33. The rocker 35 comprises a rocker hook 36 at one end that engages with the front fork 5. The fork body 7 comprises a pin 37. When the stem 10 is in the deployed configuration, the pin 37 is located within the stem 10. The rocker hook 36 engages with the pin 37 to lock the stem 10 relative to the front fork 5. The engagement of the rocker hook 36 with the pin 37 stops the stem 10 moving relative to the front fork 5.

To unlock the securing device 32, the rocker 35 comprises a button 38. The button 38 is located at the opposite end of the rocker 35 to the rocker hook 36. The rocker hook 36 is located to one side of a hinge 39 and the button 38 is located to the other side of the hinge 34. The hinge 39 permits relative motion between the rocker 35 and the securing device body 33. Motion of the button 38 towards the stem 10 causes the rocker hook 36 to disengage with the pin 37. The disengagement of the pin 37 permits the stem 10 to rotate relative to the front fork 5. Initially, the securing device body 33 moves away from the stem 10. The securing device body 33 is permitted to move away from the stem 10 as the rocker hook 36 has been disconnected from the pin 37. This movement is shown in FIG. 11.

The securing device 32 comprises a linkage 40. The linkage 40 may have an adjustable length. The linkage 40 may be adjustable my moving a first part 41 of the linkage 40 relative to a second part 42 of the linkage 40. The linkage 40 is connected between the securing device body 33 and the stem 10. The linkage 40 is pivotally connected to the securing device body 33 and the stem 10. The linkage 40 is pivotally connected to stem body 11. The linkage 40 is hinged to the securing device body 33. The linkage 40 is hinged to the stem body 11. The linkage 40 limits the motion of the stem 10 relative to the securing device body 33.

Once the rocker hook 36 has been disengaged with the pin 37, the securing device body 33 is able to rotate away from the stem 10. This is as shown in FIG. 11. Once the securing device body 33 has rotated sufficiently away from the stem 10, the stem 10 is able to rotate past the securing device body 33. The stem 10 can therefore fold relative to the front fork 5. Due to the linkage 40, the movement of the stem 10 towards the folded configuration pulls the securing device body 33 towards the stem 10. As the stem 10 reaches the folded configuration, the rocker hook 36 engages with hinge 34 which runs across the fork 5 to lock the stem 10 in the folded configuration.

To unlock the stem 10 from the folded configuration, the button 38 can be pressed by the user. Motion of the button 38 towards the stem 10 causes the rocker hook 36 to disengage from the hinge 34. The stem 10 is then permitted to rotate back to the unfolded, deployed configuration. The motion of the stem 10 and the securing device body 33 is the reverse of that described with reference to the movement from the deployed configuration to the folded configuration.

The securing device 32 is connected to the control cable 28. The securing device 32 can therefore cause the unlocking of the locking mechanism 26 at the same time as the unlocking of the stem 10. The securing device body 33 is connected to the control cable 28 so that motion of the securing device body 33 away from the stem 10 causes the unlocking of the locking mechanism 26.

The body 14 comprises a plate 43. The plate 43 extends away from the body 14. The plate 43 extends away from the first surface 15 of the body 14. The plate 43 extends away from the first surface 15 in a region of the body 14 close to the second wheel 3. The plate 43 is located proximal to the second wheel 3. The mobility device 1 comprises a rear mud guard 44. The rear mud guard 44 covers a portion of the second wheel 3. The rear mud guard 44 is located between the second wheel 3 and the plate 43. The plate 43 comprises an aperture 45. The aperture 45 is a through hole in the plate 43.

The headtube 4 may be configured to engage with the body 14. The headtube 4 may be configured to engage with the body 14 proximal to the second wheel 3. The headtube 4 may be configured to engage with the body 14 through the securing device 32. In other words, components of the securing device 32 may couple the headtube 4 to the body 14. The headtube 4 may engage with the body 14 in the folded configuration. The stem 10 may be configured to engage with the body 14. The stem 10 may be configured to engage with the body 14 proximal to the second wheel 3. The stem 10 may be configured to engage with the body 14 through the securing device 32. In other words, components of the securing device 32 may couple the stem 10 to the body 14. The stem 10 may engage with the body 14 in the folded configuration. The securing device 32 comprises a body hook 46. The body hook 46 is located between the headtube 4 and the securing device body 33. The body hook 46 is configured to engage with the aperture 45. As the stem 10 reaches the folded configuration, the body hook 46 is able to pass through the aperture 45. The body hook 46 therefore secures to the plate to stop the movement of the stem 10 and front fork 5 relative to the body 14. The rocker hook 36 being engaged with the hinge 34 stops the movement of the stem 10 and so prevents movement of the body hook 46.

When the mobility device 1 is in the folded configuration, the mobility device 1 can be carried by the user by holding on to the stem 10. The rocker hook 36 provides a first connection from the stem 10 to the body 14. The connection of the stem 10 to the front fork 5 and hence to the headtube 4 provides a second connection to the body 14. In this way the stem 10 can be used as a handle for carrying the mobility device 1.

As shown in FIGS. 1 to 7, the mobility device 1 is configured to move between a deployed configuration and a folded configuration. The first and second linkages define a first motion path that the headtube 4 moves along relative to the body 14. The first and second linkages 20, 23 permit the headtube 4 to rotate and translate relative to the body 14. Thus, the first motion path translates and rotates the headtube 4 relative to the body 14. This permits the headtube 4 to move between the deployed configuration and a folded configuration of the mobility device 1.

The motion of the headtube 4 also causes the front fork 5 to move relative to the body 14. The front fork 5 translates and rotates relative to the body 14 when moving between the deployed configuration and the folded configuration of the mobility device 1.

The headtube 4 is coupled to the first wheel 2. Therefore, the motion of the headtube 4 also causes the front wheel to move between a deployed configuration and a folded configuration of the mobility device 1. The first wheel 2 moves along a second motion path. The second motion path moves the first wheel 2 relative to the body 14. The second motion path moves the first wheel 2 so that the distance between the first wheel 2 and second wheel 3 reduces as the mobility device 1 moves from the deployed configuration to the folded configuration.

When the mobility device 1 is in the deployed configuration there is a first distance between the first rolling axis 6 and the second rolling axis 16. When the mobility device 1 is in the folded configuration there is a second distance between the first rolling axis 6 and the second rolling axis 16. The second distance is less than the first distance. In this way, the mobility device 1 has a reduced length when in the folded configuration relative to the deployed configuration.

The body 14 comprises a front edge 47. The front edge 47 is the portion of the body 14 which is the farthest forward part of the body 14. The front edge 47 is the portion of the body 14 which is located farthest forward in the primary running direction of the body 14. In the deployed configuration, the front edge 47 is the closest part of the body to the front headtube 4. In the deployed configuration, the front edge 47 is the closest part of the body to the front wheel 2.

In the deployed configuration, the front wheel 2 is located in front of the front edge 47 of the body 14. In the folded configuration, the front wheel 2 is located behind the front edge 47 of the body 14. As shown in the figures, the front wheel 2 may be located completely behind the front edge 47 of the body 14. There is a third distance between the front edge 47 of the body 14 and the second rolling axis 16. The second distance is less than the third distance.

The motion of the headtube, and hence the front wheel, causes the mobility device 1 to have an overall length that is significantly reduced. This is advantageous as it means that the mobility device 1 has an overall length in the folded configuration that is significantly reduced relative to the deployed configuration.

The first surface 15 of the body 14 may be located on a first side of the body 14. The first side of the body 14 may be on the other side of the body 14 to the running surface. In other words, the running surface may be located under the body 14 during normal use of the mobility device 1 in the deployed configuration. As such, the first side of the body 14 is above the body 14 during normal use of the mobility device 1 in the deployed configuration.

In the folded configuration, the headtube 4 may be located to the first side of the body 14. In other words, the headtube 4 may be at least partially located to the first side of the body 14 in the folded configuration. In particular, the headtube 4 may be entirely located to the first side of the body 14 in the folded configuration. Similarly, in the folded configuration, the first wheel 1 may be located to the first side of the body 14. In other words, the first wheel 1 may be at least partially located to the first side of the body 14 in the folded configuration. In particular, the first wheel 1 may be entirely located to the first side of the body 14 in the folded configuration. As a result, the headtube 4 and/or the first wheel 1 may be folded towards the first surface 15 so as to provide a compact folded configuration.

When the mobility device 1 moves between the deployed configuration and the folded configuration, the headtube 4 moves along the first motion path. The first motion path of the headtube 4 is defined by the first linkage 20 and the second linkage 23, which are rotatably mounted to the body 14. The headtube 4 moves from outboard of the front edge 47 in a general direction towards the rear wheel 3. In particular, the headtube 4 may initially rotate and/or translate upward away from the running surface. The headtube 4 may then rotate and/or translate from outboard of the front edge 47 in a general direction towards the rear wheel 3. The headtube 4 may then rotate and/or translate towards the first surface 15 of the body 14. The first motion path of the headtube 4 may at least partially be located to the first side of the body 14. The first motion path of the headtube 4 may be entirely located to the first side of body 14. In other words, the headtube 4 may only move into a position above the body 14, and cannot move into a position below the body 14.

When the headtube 4 moves between the deployed configuration to the folded configuration, the first linkage 20 and the second linkage 23 may initially rotate away from the running surface. When the headtube 4 moves between the deployed configuration to the folded configuration, the first linkage 20 and the second linkage 23 may rotate towards the first surface 15 of the body 14. In other words, the first linkage 20 and the second linkage 23 may both rotate over the first surface 15 of the body 14 and/or to the first side of the body 14.

As the first wheel 2 is mounted to the headtube 4, the second motion path of the first wheel 2 may follow a similar path to the first motion path of the headtube 4, albeit displaced from the first motion path. The second motion path of the first wheel 2 is also defined by the first linkage 20 and the second linkage 23, which are rotatably mounted to the body 14. The first wheel 2 moves from outboard of the front edge 47 in a general direction towards the rear wheel 3. In particular, the first wheel 2 may initially rotate and/or translate upward away from the running surface. The first wheel 2 may then rotate and/or translate from outboard of the front edge 47 in a general direction towards the rear wheel 3. The first wheel 2 may then rotate and/or translate towards the first surface 15 of the body 14. The second motion path of the first wheel 2 may at least partially be located to the first side of the body 14. The second motion path of the first wheel 2 may be entirely located to the first side of body 14. In other words, the first wheel 2 may only move into a position above the body 14, and cannot move into a position below the body 14.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description, it will be evident to a person skilled in the art that various modifications may be made within the scope of the invention.

1. A mobility device for transporting a user, the mobility device comprising:
a first wheel;
a second wheel;
a headtube coupled to the first wheel;
a body configured to support the user, the body being coupled to the second wheel;
a first linkage connected between the headtube and the body, the first linkage being pivotally coupled to the headtube and to the body; and
a second linkage connected between the headtube and the body, the second linkage being pivotally coupled to the headtube and to the body;
wherein the first and second linkages permit the headtube to rotate and translate relative to the body to move between a deployed configuration and a folded configuration of the mobility device; and
wherein one of the first and second linkages comprises a protrusion, and the body comprises a locking mechanism to hold the mobility device in the deployed configuration, the protrusion fitting into the locking mechanism to hold the mobility device in the deployed configuration.

2. The mobility device according to claim 1, wherein the headtube is configured to engage with the body proximal to the second wheel in the folded configuration.

3. A mobility device for transporting a user, the mobility device comprising:
a first wheel;
a second wheel;
a headtube coupled to the first wheel;
a body configured to support the user, the body being coupled to the second wheel;
a first linkage connected between the headtube and the body, the first linkage being pivotally coupled to the headtube and to the body; and
a second linkage connected between the headtube and the body, the second linkage being pivotally coupled to the headtube and to the body;
wherein the first and second linkages permit the headtube to rotate and translate relative to the body to move between a deployed configuration and a folded configuration of the mobility device, and
wherein the headtube is configured to engage with the body proximal to the second wheel in the folded configuration.

4. The mobility device according to claim 1, the mobility device comprising a front fork, the front fork being attached to the first wheel to permit the first wheel to rotate about a first rolling axis; wherein the first wheel is coupled to the headtube by the front fork so that the first rolling axis has freedom to rotate relative to the headtube.

5. The mobility device according to claim 1, wherein the body is coupled to the second wheel to permit the second wheel to rotate about a second rolling axis.

6. The mobility device according to claim 1, wherein the first wheel has a first rolling axis and the second wheel has a second rolling axis; in the deployed configuration the mobility device has a first distance between the first rolling axis and the second rolling axis; in the folded configuration the mobility device has a second distance between the first rolling axis and the second rolling axis; and the second distance is less than the first distance.

7. The mobility device according to claim 1, wherein in the folded configuration the first wheel is located inboard of a front edge of the body.

8. The mobility device according to claim 1, wherein in the deployed configuration the first wheel is located outboard of a front edge of the body.

9. The mobility device according to claim 1, wherein the first linkage is pivotally coupled to the headtube at a first location, the second linkage is pivotally coupled to the headtube at a second location, and the first location is positioned closer to the first wheel on the headtube than the second location.

10. The mobility device according to claim 1, wherein the first linkage is pivotally coupled to the body at a third location, the second linkage is pivotally coupled to the body at a fourth location, and the fourth location is positioned closer to the second wheel on the body than the third location.

11. The mobility device according to claim 1, wherein in the deployed configuration the first wheel is positioned to contact a running surface.

12. The mobility device according to claim 1, wherein the first linkage comprises a curved profile proximal to where the first linkage is coupled to the body and a straight profile proximal to where the first linkage is coupled to the headtube.

13. The mobility device according to claim 1, wherein the second linkage comprises a curved profile proximal to where the second linkage is coupled to the body and a straight profile proximal to where the second linkage is coupled to the headtube.

14. The mobility device according to claim 1, the mobility device comprising a front fork, a stem, and a securing device, the front fork and the stem being pivotally connected together and the securing device limiting the motion of the stem relative to the front fork so that the stem and front fork are lockable in a deployed configuration and a folded configuration.

15. A mobility device according to claim 14, wherein the securing device comprises a button to unlock the securing device and the securing device is coupled to the locking mechanism to unlock the locking mechanism when the securing device unlocks.

16. The mobility device according to claim 1, wherein the first wheel has a first rolling axis and the second wheel has a second rolling axis; in the folded configuration the mobility device has a second distance between the first rolling axis and the second rolling axis; the mobility device has a third distance between a front edge of the body and the second rolling axis; and the second distance is less than the third distance.

17. The mobility device according to claim 14, wherein the headtube is configured to engage with the body proximal to the second wheel in the folded configuration through the securing device.

18. The mobility device according to claim 14, wherein the stem is configured to engage with the body proximal to the second wheel in the folded configuration through the securing device.

19. The mobility device according to claim 14, wherein the securing device comprises a body hook, and the body comprises a plate located proximal to the second wheel, the plate comprising an aperture, the body hook being configured to engage with the aperture in the folded configuration.

20. The mobility device according to claim 19, wherein the plate extends away from a first surface of the body, the first surface facing away from a running surface that the wheels contact with when the mobility device is in the deployed configuration.
